(19) United States
(12) Patent Application Publication
(10) Pub. No.: US 2007/0067154 A1
(43) Pub. Date: Mar. 22, 2007

(54) Language translation system

(75) Inventor: Norbert Robert Ryan III, New York, NY (US)

Correspondence Address: SCHMEISER, OLSEN & WATTS, 22 CENTURY HILL DRIVE, SUITE 302, LATHAM, NY, 12110, US

(73) Assignee: International Business Machines Corporation, Armonk, NY (US)

(21) Appl. No.: 11/233,442

(22) Filed: Sep. 22, 2005

(51) Int. Cl. G06F 17/20

(52) U.S. Cl. 704/8

(57) ABSTRACT

A language translation system and method. The system comprises a server. The server comprises a file system within a memory device. The file system comprises a directory comprising a plurality of subdirectories. The server apparatus receives a data file in a first language. The data file is stored in the directory. The data file is separated into a plurality of sections. A first copy of the plurality of sections is stored in a first subdirectory. A second language is selected for translation of the plurality of sections. A second copy of the plurality of sections is retrieved. A first section of the second copy is translated into the second language. The first section comprising the second language is stored in a second subdirectory. A second section of the second copy is translated into said second language. The second section comprising the second language is stored in the second subdirectory.

### BACKGROUND OF THE INVENTION 1. Technical Field

The present invention relates to a system and associated method for language translation of data files. 2. Related Art

Modifying files within a system typically requires a complicated series of steps. Performing a complicated series of steps may be very time consuming. Therefore there exists a need for a simple means for modifying files within a system.

### SUMMARY OF THE INVENTION

The present invention provides a translation method, comprising:

providing a computing system comprising a server apparatus, said server apparatus comprising a file system within a memory device, said file system comprising a directory, said directory comprising a plurality of subdirectories;

receiving by said server apparatus, a data file in a first language;

storing said data file in said directory;

separating said data file into a first section and a second section, said first section comprising a first title and said second section comprising a second title;

storing a first copy of said first section and said second section in a first subdirectory of said plurality of subdirectories;

selecting a second language for translation of said first section and said second section;

retrieving a second copy of said first section and said second section;

translating said first section of said second copy into said second language;

storing said first section comprising said second language and said first title in a second subdirectory of said plurality of subdirectories;

translating said second section of said second copy into said second language; and

storing said second section comprising said second language and said second title in said second subdirectory of said plurality of subdirectories.

The present invention provides a computing system comprising a processor coupled to a computer-readable memory unit, said memory unit comprising a file system and instructions that when executed by the processor implement an translation method, said file system comprising a directory, said directory comprising a plurality of subdirectories, said method comprising;

receiving by said server apparatus, a data file in a first language;

storing said data file in said directory;

separating said data file into a first section and a second section, said first section comprising a first title and said second section comprising a second title;

storing a first copy of said first section and said second section in a first subdirectory of said plurality of subdirectories;

selecting a second language for translation of said first section and said second section;

retrieving a second copy of said first section and said second section;

translating said first section of said second copy into said second language;

storing said first section comprising said second language and said first title in a second subdirectory of said plurality of subdirectories;

translating said second section of said second copy into said second language; and

storing said second section comprising said second language and said second title in said second subdirectory of said plurality of subdirectories.

The present invention provides a computer program product, comprising a computer usable medium having file system and a computer readable program code embodied therein, said computer readable program code comprising an algorithm adapted to implement an translation method within a computing system, said file system comprising a directory, said directory comprising a plurality of subdirectories, said method comprising:

receiving by said server apparatus, a data file in a first language;

storing said data file in said directory;

separating said data file into a first section and a second section, said first section comprising a first title and said second section comprising a second title;

storing a first copy of said first section and said second section in a first subdirectory of said plurality of subdirectories;

selecting a second language for translation of said first section and said second section;

retrieving a second copy of said first section and said second section;

translating said first section of said second copy into said second language;

storing said first section comprising said second language and said first title in a second subdirectory of said plurality of subdirectories;

translating said second section of said second copy into said second language; and

storing said second section comprising said second language and said second title in said second subdirectory of said plurality of subdirectories.

The present invention provides a process for integrating computing infrastructure, comprising integrating computer-readable code into a computer system, wherein said computer system comprises a computer usable medium, wherein said computer usable medium comprises a file system, wherein said file system comprises a directory, wherein said directory comprises a plurality of subdirectories, and wherein the code in combination with the computer system is capable of performing a translation method comprising:

receiving by said server apparatus, a data file in a first language;

storing said data file in said directory;

separating said data file into a first section and a second section, said first section comprising a first title and said second section comprising a second title;

storing a first copy of said first section and said second section in a first subdirectory of said plurality of subdirectories;

selecting a second language for translation of said first section and said second section;

retrieving a second copy of said first section and said second section;

translating said first section of said second copy into said second language;

storing said first section comprising said second language and said first title in a second subdirectory of said plurality of subdirectories;

translating said second section of said second copy into said second language; and

storing said second section comprising said second language and said second title in said second subdirectory of said plurality of subdirectories.

The present invention advantageously provides a system and associated method system for modifying files within a system.

### BRIEF DESCRIPTION OF THE DRAWINGS

FIG. 1 illustrates a block diagram view of a system for managing document language translations, in accordance with embodiments of the present invention.

FIG. 2 illustrates a flowchart illustrating an algorithm describing the translation process used by the system of FIG. 1, in accordance with embodiments of the present invention.

FIG. 3 illustrates a computer system used for multiple language translations, in accordance with embodiments of the present invention.

### DETAILED DESCRIPTION OF THE INVENTION

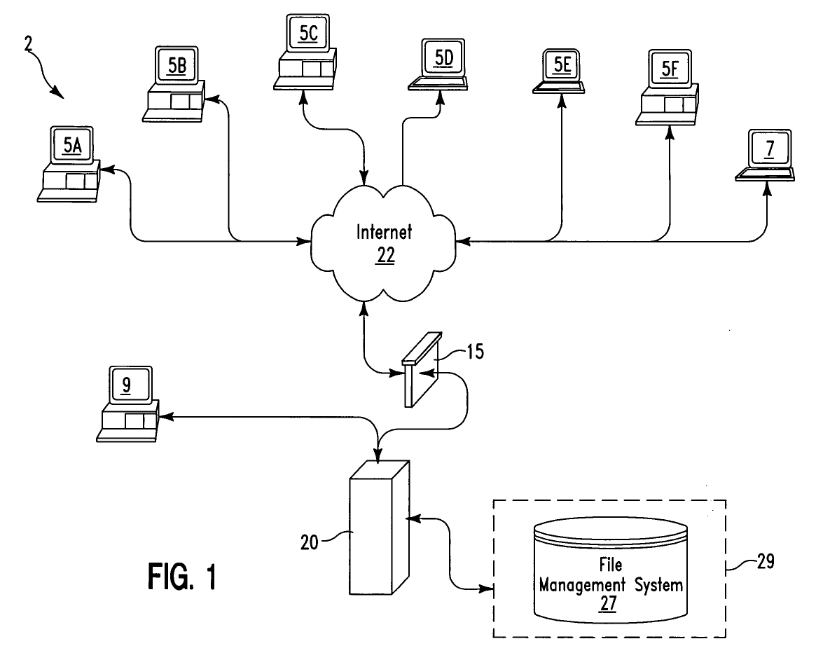

FIG. 1 illustrates a block diagram view of a system 2 for managing document language translations, in accordance with embodiments of the present invention. The system 2 comprises a plurality of translator/translated document terminals 5A . . . 5F and a document creator terminal 7 connected through the Internet 22 to a server computer 20. The system 2 additionally comprises a document manager computer 9 connected to the server computer 20 and a firewall 15 connected between the Internet and the server computer 20. The firewall 15 prevents any unauthorized access to the server computer 20. The server computer 20 comprises a memory structure 29. The memory structure 29 may be located internally within the server computer 20. Alternatively, the memory structure 29 may be located external to the server computer 20. The memory structure 29 comprises a file management system 27. Each of the computer terminals 5A . . . 5F, the document creator terminal 7, and the document manager computer 9 may comprise any type of computer including, inter alia, a personal computer (P.C.), a laptop computer, etc.

The system 2 of FIG. 1 allows a person using the document creator terminal 7 to create a document(s) in a first language and transmit the document to the server computer 20 for multiple language translations. The file management system 27 comprises a directory structure for storing the document(s) and allowing translators to access the document for translation as described, infra. Additionally, the file management system 27 allows users to access the translated documents. The translators and the users may access the documents using any of the translator/translated document terminals 5A . . . 5F. A content manager using the document manager computer 9 divides the document received by the server computer 20 into discreet sections (e.g., paragraphs) and gives each discreet section a unique file name. The content manager stores the discreet sections (e.g., paragraphs) of the document in a subdirectory for the first language. The subdirectory may comprise a naming convention that includes an abbreviation for the first language and a county code for a specified country. For example, if the document is in English (e.g., first language is in English) and the country is the United States then the naming convention for the subdirectory would be en_US (“en” for English and “US” for united states). The directory structure comprising the discreet sections (e.g., paragraphs) of the document in the subdirectory is accessible to translators (people that translate text) through a website hosted by the server computer 20. The translators may be located all over the world. A translator using one of translator computer terminals 5A . . . 5F connects to the website hosted by the server computer 20. The document comprising discreet sections (with the unique file names) is selected for translation to a second language. The server computer 20 posts a first section of the document on the website for translation. The translator provides translation for the section and the translated section is stored in a separate directory for the second language. For example, if the document is in translated to French (e.g., second language is French) and the country is Canada then the naming convention for the second subdirectory would be fr_CA (“fr” for French and “CA” for Canada). Each discreet translated section (e.g., paragraphs) in the second directory comprises the same unique file name as each corresponding discreet section in the first subdirectory. For example, the first discreet section of the original document (i.e., in English) and the first discreet translated section of the document (i.e., in French) document each comprise a same file name (e.g., paragraph0001.txt) in the corresponding subdirectories. Each section of the document is individually posted on the website so that the translator may translate and store each section individually until the entire document has been translated. Each translated section is stored in the subdirectory for the second language. A user accessing any of terminals 5A . . . 5F may connect to the website and access the subdirectory for the second language to obtain the translated (i.e., in the second language) document.

An example for implementing the multiple language translations using the directory structure within the system 2 of FIG. 1 is illustrated by the following tables (Tables 1-3) and associated descriptions.

TABLE 1

| | Language + | |
|---|---|---|
| Document name | Country code | File/Paragraph name |
| document3429 | en_US | main-title |
| | | main-subheading |
| | | paragraph001 |
| | | paragraph002 |
| | | paragraph003 |
| | | paragraphN-1 |
| | | paragraphN |
| | es_MX | |
| | es_ES | |
| | fr_FR | |
| | fr_CA | |
| | ja_JP | |
| | zh_CN | |
| | pt_BR | |

Initially, an original document (i.e., document 3429 in table 1) is written in English and divided into the discreet sections (i.e., sections of text or paragraphs) in column 3 of table 1 in directory “File/Paragraph name”. The original document in English (en_US) will be translated into Spanish for Mexico (es_MX), Spanish for Spain (es_ES), French for France (fr_FR), French for Canada (fr_CA), Japanese for Japan (ja_JP), Mandarin for China (zh_CN), and Portuguese for Brazil (ptBR). In table 1, the document has not been translated into any of the above languages, but the translation specific target directories have been set. In tables 1-3 below, both columns “Document name” and “Language+Country code” are directories in the file management system 27 of FIG. 1. The File/Paragraph name is a file in the subdirectory of the Language+Country code. Therefore, “en_US” (in tables 1-3) is a subdirectory in the directory “document3429”. The discreet section “main-title” is a file in the subdirectory “en_US”. “Document3429” is a subdirectory of a higher level directory that is not shown in this example.

TABLE 2

| | language + | |
|---|---|---|
| document name | country code | file/paragraph name |
| document3429 | en_US | main-title |
| | | main-subheading |
| | | paragraph001 |
| | | paragraph002 |
| | | paragraph003 |
| | | paragraphN-1 |
| | es_MX | paragraphN |
| | es_ES | |
| | fr_FR | |
| | fr_CA | main-title |
| | ja_JP | |
| | zh_CN | |
| | pt_BR | |

Table 2 illustrates a process used by a French-Canadian (fr_CA) translator. Initially, the French-Canadian (fr_CA) translator goes to a web site generated by the server computer 20 in FIG. 1 that is set up specifically for the translators. He/she identifies the English document (i.e., document3429) to be translated and the language (fr_CA) to which he/she will be translating. The web site displays, in English, the first discreet section to be translated (“main-title”). Just below the English text (i.e., on a monitor for one of terminals 5A . . . 5F), there is a input text area where the French-Canadian translator types his/her translation of “main-title.” Upon enabling a submit button on the terminal 5A . . . 5F, the French-Canadian translator is asked to confirm his/her translation. Upon enabling a confirm button on the terminal 5A . . . 5F, the web site application (i.e., within the server 20) saves his/her French-Canadian translation of “main-title”. in the fr_CA directory. The French-Canadian file name is given the same name as the English-United States version of the file. The updated file system is illustrated in table 2.

TABLE 3

| | language + | |
|---|---|---|
| document name | country code | file/paragraph name |
| document3429 | en_US | main-title |
| | | main-subheading |
| | | paragraph001 |
| | | paragraph002 |
| | | paragraph003 |
| | | paragraphN-1 |
| | | paragraphN |
| | es_MX | |
| | es_ES | |
| | fr_FR | |
| | fr_CA | main-title |
| | | main-subheading |
| | | paragraph001 |
| | | paragraph002 |
| | | paragraph003 |
| | | paragraphN-1 |
| | | paragraphN |
| | ja_JP | |
| | zh_CN | |
| | pt_BR | |

Table 3 illustrates a continuation of the process used by the French-Canadian (fr_CA) translator to translate the entire original document (i.e., each discreet section or paragraph). After the “main-title” file is saved in the fr_CA directory, the web site shows the next discreet section or paragraph, “main-subheading” to the French-Canadian translator for translation. The process repeats itself until all of the discreet sections or paragraphs in the original document have been translated from English to French. Upon conclusion of the entire translation of all of the discreet section or paragraphs, the updated file system is illustrated in table 3.

The document (i.e., for document3429) translation process described with reference to table 1-3 is repeated for each of the languages (i.e., Spanish for Mexico (es_MX), Spanish for Spain (es_ES), French for France (fr_FR), Japanese for Japan (ja_JP), Mandarin for China (zh_CN), and Portuguese for Brazil (pt_BR). Each of the translators for each of the languages logs into the translation website generated by the server computer 20 to perform the language specific translation from the original English document into the appropriate language. Each file may be encoded using UTF-8 encoding. This encoding system (i.e., UTF-8) supports all modern languages. Therefore, if someone opens the file “paragraph003” in the fr_CA directory, they would see a discreet section or paragraph in French.

The unique method/process (describe, supra) of dividing the document into discreet sections or paragraphs and employing the naming convention (i.e., described in tables 1-3) for directories and file names simplifies the use these translated section or paragraphs for many purposes. For example, an HTML developer could create and HTML template for a web site. Based on the user's country and language preference, this HTML template would then include the files from the appropriate language+country choice. The same HTML template could be used for all the available languages. Therefore, the HTML developer is not required to know anything about various translations. The user doesn't have to sort through translated files and determine whether the file is the Chinese, Korean or Japanese translation. The user knows that paragraph002 for the Mandarin-Chinese translation is always going to be in the directory named zh_CN with a file name of paragraph002.

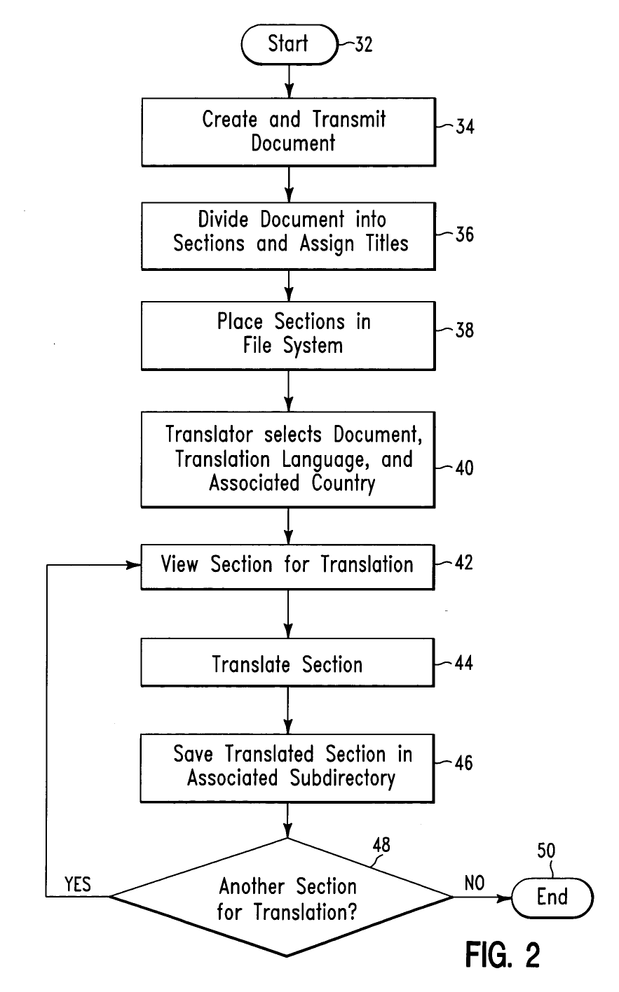

FIG. 2 illustrates a flowchart illustrating an algorithm describing the translation process used by the system 2 of FIG. 1, in accordance with embodiments of the present invention. In step 32, the process is initiated. In step 34, a document creator at document creator terminal 7 generates a document in a first language (e.g., English) and transmits the document to the server computer 20. In step 36, an administrator using document manager computer 9 divides the document into discreet sections or paragraphs and assigns each discreet section or paragraph a title. In step 38, the administrator places the discreet sections or paragraphs into the file management system 27. In step 40, a translator using any of terminals 5A . . . 5F selects the document (e.g., if multiple documents exist), a translation language, and associated country (e.g., fr_CA). In step 42, the server computer displays a first discreet section or paragraph of the selected document for the translator. In step 44, the translator translates the first discreet section or paragraph into the selected translation language. In step 46, the translated first discreet section or paragraph is saved in the associated subdirectory for the selected language. In step 48, the server computer 20 determines if another discreet section or paragraph for the selected document is available for translation. If in step 48, it is determined that another discreet section or paragraph for the selected document is available for translation then step 42 is repeated. If in step 48, it is determined that another discreet section or paragraph for the selected document is not available for translation (i.e., entire selected document has been translated) then the process ends in step 50. The process described by the algorithm of FIG. 2 may be repeated for multiple documents in multiple languages.

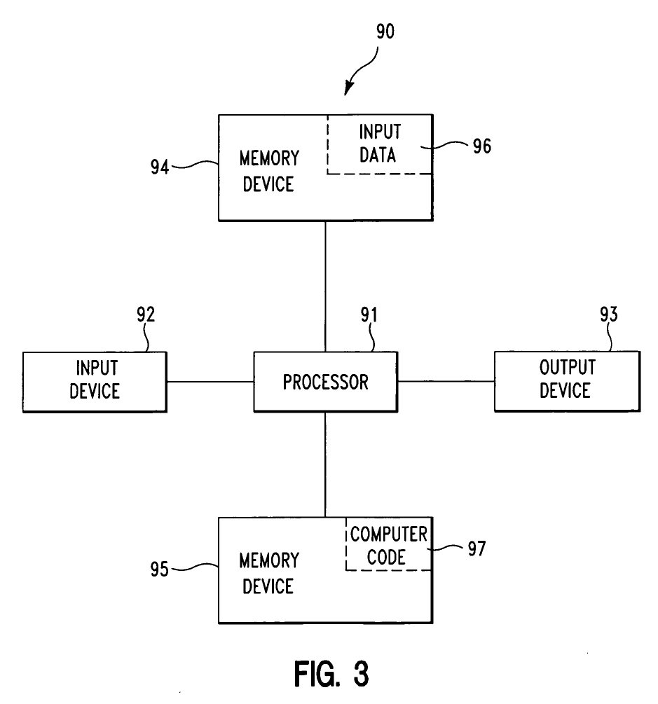

FIG. 3 illustrates a computer system 90 (i.e., comprised by the server computer 20 and memory structure 29 of FIG. 1) used for multiple language translations, in accordance with embodiments of the present invention. The computer system 90 comprises a processor 91, an input device 92 coupled to the processor 91, an output device 93 coupled to the processor 91, and memory devices 94 and 95 each coupled to the processor 91. The input device 92 may be, inter alia, a keyboard, a mouse, etc. The output device 93 may be, inter alia, a printer, a plotter, a computer screen (e.g., monitor 110), a magnetic tape, a removable hard disk, a floppy disk, etc. The memory devices 94 and 95 may be, inter alia, a hard disk, a floppy disk, a magnetic tape, an optical storage such as a compact disc (CD) or a digital video disc (DVD), a dynamic random access memory (DRAM), a read-only memory (ROM), etc. The memory device 95 includes a computer code 97. The computer code 97 includes an algorithm used for multiple language translations. The processor 91 executes the computer code 97. The memory device 94 includes input data 96. The input data 96 includes input required by the computer code 97. The output device 93 displays output from the computer code 97. Either or both memory devices 94 and 95 (or one or more additional memory devices not shown in FIG. 5) may comprise any of the algorithm of FIG. 2 and may be used as a computer usable medium (or a computer readable medium or a program storage device) having a computer readable program code embodied therein and/or having other data stored therein, wherein the computer readable program code comprises the computer code 97. Generally, a computer program product (or, alternatively, an article of manufacture) of the computer system 90 may comprise said computer usable medium (or said program storage device).

Thus the present invention discloses a process for deploying or integrating computing infrastructure, comprising integrating computer-readable code into the computer system 90, wherein the code in combination with the computer system 90 is capable of performing a method for multiple language translations.

While FIG. 3 shows the computer system 90 as a particular configuration of hardware and software, any configuration of hardware and software, as would be known to a person of ordinary skill in the art, may be utilized for the purposes stated supra in conjunction with the particular computer system 90 of FIG. 4. For example, the memory devices 94 and 95 may be portions of a single memory device rather than separate memory devices.

While embodiments of the present invention have been described herein for purposes of illustration, many modifications and changes will become apparent to those skilled in the art. Accordingly, the appended claims are intended to encompass all such modifications and changes as fall within the true spirit and scope of this invention.

What is claimed is:

1. A translation method, comprising:
providing a computing system comprising a server apparatus, said server apparatus comprising a file system within a memory device, said file system comprising a directory, said directory comprising a plurality of subdirectories;
receiving by said server apparatus, a data file in a first language;
storing said data file in said directory;
separating said data file into a first section and a second section, said first section comprising a first title and said second section comprising a second title;
storing a first copy of said first section and said second section in a first subdirectory of said plurality of subdirectories;
selecting a second language for translation of said first section and said second section;
retrieving a second copy of said first section and said second section;
translating said first section of said second copy into said second language;
storing said first section comprising said second language and said first title in a second subdirectory of said plurality of subdirectories;
translating said second section of said second copy into said second language; and
storing said second section comprising said second language and said second title in said second subdirectory of said plurality of subdirectories.

2. The method of claim 1, further comprising:
selecting a third language for translation of said first section and said second section;
retrieving a third copy of said first section and said second section;
translating said first section of said third copy into said third language;
storing said first section comprising said third language and said first title in a third subdirectory of said plurality of subdirectories;
translating said second section of said third copy of said plurality of sections into said third language; and
storing said second section comprising said third language and said second title in said third subdirectory of said plurality of subdirectories.

3. The method of claim 2, wherein said first language, said second language, and said third language each comprise a different language.

4. The method of claim 1, wherein each said plurality of subdirectories comprises a naming convention comprising a different specified language and associated county code.

5. The method of claim 1, wherein said data file comprises a document, and wherein each of said first section and said second section comprises a paragraph of said document.

6. The method of claim 1, further comprising posting said second copy on a website generated by said server apparatus for said translating said first section and said second section.

7. The method of claim 6, further comprising posting said first section comprising said second language and said second section comprising said second language on said website.

8. The method of claim 1, wherein said translating said first section and said second section is performed by a translator in a remote location.

9. A computing system comprising a processor coupled to a computer-readable memory unit, said memory unit comprising a file system and instructions that when executed by the processor implement an translation method, said file system comprising a directory, said directory comprising a plurality of subdirectories, said method comprising;
receiving by said server apparatus, a data file in a first language;
storing said data file in said directory;
separating said data file into a first section and a second section, said first section comprising a first title and said second section comprising a second title;
storing a first copy of said first section and said second section in a first subdirectory of said plurality of subdirectories;
selecting a second language for translation of said first section and said second section;
retrieving a second copy of said first section and said second section;
translating said first section of said second copy into said second language;
storing said first section comprising said second language and said first title in a second subdirectory of said plurality of subdirectories;
translating said second section of said second copy into said second language; and
storing said second section comprising said second language and said second title in said second subdirectory of said plurality of subdirectories.

10. The computing system of claim 9, wherein said method further comprises:
selecting a third language for translation of said first section and said second section;
retrieving a third copy of said first section and said second section;
translating said first section of said third copy into said third language;
storing said first section comprising said third language and said first title in a third subdirectory of said plurality of subdirectories;
translating said second section of said third copy of said plurality of sections into said third language; and
storing said second section comprising said third language and said second title in said third subdirectory of said plurality of subdirectories.

11. The computing system of claim 10, wherein said first language, said second language, and said third language each comprise a different language.

12. The computing system of claim 9, wherein each of said plurality of subdirectories comprises a naming convention comprising a different specified language and associated county code.

13. The computing system of claim 9, wherein said data file comprises a document, and wherein each of said first section and said second section comprises a paragraph of said document.

14. The computing system of claim 9, wherein said method further comprises posting said second copy on a website generated by said server apparatus for said translating said first section and said second section.

15. The computing system of claim 14, wherein said method further comprises posting said first section comprising said second language and said second section comprising said second language on said website.

16. The computing system of claim 9, wherein said translating said first section and said second section is performed by a translator in a remote location.

17. A computer program product, comprising a computer usable medium having file system and a computer readable program code embodied therein, said computer readable program code comprising an algorithm adapted to implement an translation method within a computing system, said file system comprising a directory, said directory comprising a plurality of subdirectories, said method comprising:
receiving by said server apparatus, a data file in a first language;
storing said data file in said directory;
separating said data file into a first section and a second section, said first section comprising a first title and said second section comprising a second title;
storing a first copy of said first section and said second section in a first subdirectory of said plurality of subdirectories;
selecting a second language for translation of said first section and said second section;
retrieving a second copy of said first section and said second section;
translating said first section of said second copy into said second language;
storing said first section comprising said second language and said first title in a second subdirectory of said plurality of subdirectories;
translating said second section of said second copy into said second language; and
storing said second section comprising said second language and said second title in said second subdirectory of said plurality of subdirectories.

18. The computer program product of claim 17, wherein said method further comprises:
selecting a third language for translation of said first section and said second section;
retrieving a third copy of said first section and said second section;
translating said first section of said third copy into said third language;
storing said first section comprising said third language and said first title in a third subdirectory of said plurality of subdirectories;
translating said second section of said third copy of said plurality of sections into said third language; and
storing said second section comprising said third language and said second title in said third subdirectory of said plurality of subdirectories.

19. The computer program product of claim 18, wherein said first language, said second language, and said third language each comprise a different language.

20. The computer program product of claim 17, wherein each of said plurality of subdirectories comprises a naming convention comprising a different specified language and associated county code.

21. The computer program product of claim 17, wherein said data file comprises a document, and wherein each of said first section and said second section comprises a paragraph of said document.

22. The computer program product of claim 17, wherein said method further comprises posting said second copy on a website generated by said server apparatus for said translating said first section and said second section.

23. The computer program product of claim 22, wherein said method further comprises posting said first section comprising said second language and said second section comprising said second language on said website.

24. The computer program product of claim 17, wherein said translating said first section and said second section is performed by a translator in a remote location.

25. A process for integrating computing infrastructure, comprising integrating computer-readable code into a computer system, wherein said computer system comprises a computer usable medium, wherein said computer usable medium comprises a file system, wherein said file system comprises a directory, wherein said directory comprises a plurality of subdirectories, and wherein the code in combination with the computer system is capable of performing a translation method comprising:
receiving by said server apparatus, a data file in a first language;
storing said data file in said directory;
separating said data file into a first section and a second section, said first section comprising a first title and said second section comprising a second title;
storing a first copy of said first section and said second section in a first subdirectory of said plurality of subdirectories;
selecting a second language for translation of said first section and said second section;
retrieving a second copy of said first section and said second section;
translating said first section of said second copy into said second language;
storing said first section comprising said second language and said first title in a second subdirectory of said plurality of subdirectories;
translating said second section of said second copy into said second language; and
storing said second section comprising said second language and said second title in said second subdirectory of said plurality of subdirectories.

26. The process of claim 25, wherein said method further comprises:
selecting a third language for translation of said first section and said second section;
retrieving a third copy of said first section and said second section;
translating said first section of said third copy into said third language;
storing said first section comprising said third language and said first title in a third subdirectory of said plurality of subdirectories;
translating said second section of said third copy of said plurality of sections into said third language; and
storing said second section comprising said third language and said second title in said third subdirectory of said plurality of subdirectories.

27. The process of claim 26, wherein said first language, said second language, and said third language each comprise a different language.

28. The process of claim 25, wherein each of said plurality of subdirectories comprises a naming convention comprising a different specified language and associated county code.

29. The process of claim 25, wherein said data file comprises a document, and wherein each of said first section and said second section comprises a paragraph of said document.

30. The process of claim 25, wherein said method further comprises posting said second copy on a website generated by said server apparatus for said translating said first section and said second section.

31. The process of claim 30, wherein said method further comprises posting said first section comprising said second language and said second section comprising said second language on said website.

32. The process of claim 25, wherein said translating said first section and said second section is performed by a translator in a remote location.
